(19) United States
(12) Patent Application Publication
(10) Pub. No.: US 2014/0182197 A1
(43) Pub. Date: Jul. 3, 2014

(54) ROTARY TYPE AUTOMATIC AGRICULTURAL CULTIVATING EQUIPMENT

(71) Applicant: FUNG GIN DA ENERGY SCIENCE AND TECHNOLOGY CO., LTD., Neipu Township (TW)

(72) Inventor: Chun-Neng Chung, Neipu Township (TW)

(73) Assignee: Fung Gin Da Energy Science and Technology Co., Ltd., Neipu Township (TW)

(21) Appl. No.: 13/733,400

(22) Filed: Jan. 3, 2013

(51) Int. Cl. A01G 9/00

(52) U.S. Cl. CPC A01G 9/00
USPC 47/1.7

(57) ABSTRACT

Agricultural cultivating equipment includes a support unit, a rotating unit, a driving unit for driving the rotating unit, a transmission unit extending around the rotating unit, a plurality of loading units, and a supply unit. The transmission unit includes a plurality of hangers. The loading units are disposed respectively on the hangers. Each of the loading units is circulatable between an upper limit position and a lower limit position. The supply unit includes a water supplying device for supplying water into the loading units, and a lighting device for lighting the loading units.

### BACKGROUND OF THE INVENTION

1. Field of the Invention

This invention relates to agricultural cultivating equipment, and more particularly to rotary type automatic agricultural cultivating equipment.

2. Description of the Related Art

Referring to FIGS. 1 and 2, conventional agricultural cultivating equipment disclosed in Taiwanese Utility Model Republication No. M417868 is used for cultivating and producing crops. The conventional agricultural cultivating equipment includes two spaced-apart primary supports 12, two secondary supports 12 disposed respectively at left and right sides of the main support 11, a plurality of flowerpots 13 (only one is shown in FIG. 1) hung on the secondary supports 12, two water collecting reservoirs 14 each disposed under a vertical row of the flowerpots 13, two water pumps 15 (only one is shown in FIG. 1) disposed respectively in the water collecting reservoirs 14, a plurality of lighting members 16 disposed between the primary supports 11, a light transmissive plate 17 disposed on and above the main supports 11 and the secondary supports 12, a light reflecting plate 18 connected to bottom ends of the main plates 11 and the secondary plates 12, and two water conduits 19 (only one is shown in FIG. 1) connected respectively to the pumps 15.

During watering, the pumps 15 are operated to draw water from the water collecting reservoirs 14. Hence, the water flows through the water conduits 19 into the uppermost flowerpots 13, and drop into the remaining flowerpots 13. When the lowermost flowerpots 13 are filled with water, redundant water flows from discharge holes (not shown) in bottom ends of the lowermost flower pots 13 into the water collecting reservoirs 14. To light the crops, the lighting members 15 are actuated, and sunlight is emitted onto the flowerpots 13 through the light transmissive plate 17. In addition, the light emitted from the lighting members 15 and the sunlight passing through the light transmissive plate 17 onto the light reflecting plate 18 can be reflected by the light reflecting plate 18. As such, a space defined between the primary supports 11 and between the secondary plates 12 is full of light.

By hanging the flowerpots 13 on the secondary supports 12, the aforesaid conventional agricultural cultivating equipment is suitable for mass production. However, since water flows from the uppermost flowerpots 13 into the lowermost flowerpots 13, the conventional agricultural cultivating equipment suffers from the following disadvantages:
(1) When water drops along the flowerpots 13, distribution of water in the flowerpots 13 is non-uniform. Furthermore, redundant fertilizer and metabolite are accumulated within the lowermost flowerpots 13, which is harmful to the crops in the lowermost flowerpots 13.
(2) Since the positions of the flowerpots 13 are different, after the conventional agricultural cultivating equipment is used for a long time period, the growth conditions of the crops in the flowerpots 13 are non-uniform.
(3) It is difficult to manage and harvest the crops in the flowerpots 13 disposed on upper end portions of the secondary supports 12.

### SUMMARY OF THE INVENTION

The object of this invention is to provide rotary type agricultural cultivating equipment that can overcome the aforesaid disadvantages associated with the prior art.

According to this invention, rotary type automatic agricultural cultivating equipment includes a support unit, a rotating unit, a driving unit, a transmission unit, a plurality of loading units, a supply unit, and a control unit.

The rotating unit includes two axles disposed rotatably on the support unit and spaced vertically apart from and aligned with each other, and a first rotary wheel unit including two first rotary wheels sleeved respectively and fixedly on the axles.

The driving unit is connected to at least one of the axles for driving rotation of the one of the axles and, thus, a corresponding one of the first rotary wheels relative to the support unit.

The transmission unit includes a first transmission member disposed around the first rotary wheel unit such that rotation of the one of the first rotary wheels results in movement of the first transmission member around the first rotary wheel unit, and a plurality of spaced-apart hangers disposed on at least one of two opposite sides of the first transmission member.

The loading units are disposed respectively on the hangers. Each of the loading units is circulatable between an upper limit position and a lower limit position, and has a crop loading area.

The supply unit includes a water supplying device for supplying water into the crop loading areas of the loading units, and a lighting device adjacent to the transmission unit for lighting the crop loading areas of the loading units.

The control unit is electrically connected to the driving unit and the supply unit for emitting a control signal to control actuation and rotational speed of the driving unit, amount and time of water supplied by the water supplying device, and at least one of lighting time, lighting angle and light intensity of the lighting device.

Since the loading units are circulatable, uniform water distribution, homogeneous growth conditions of the crops, and easy management and harvest of the crops can be achieved.

### BRIEF DESCRIPTION OF THE DRAWINGS

These and other features and advantages of this invention will become apparent in the following detailed description of the preferred embodiments of this invention, with reference to the accompanying drawings, in which:

FIG. 1 is an exploded perspective view of conventional agricultural cultivating equipment disclosed in Taiwanese Utility Model Patent Publication No. 417868;

FIG. 2 is a schematic view illustrating use of the conventional agricultural cultivating equipment;

FIG. 3 is a perspective view of the first preferred embodiment of rotary type automatic agricultural cultivating equipment according to this invention;

FIG. 4 is a fragmentary side view of the first preferred embodiment, illustrating the relationship between a first rotary wheel of a first rotary wheel unit and a first transmission member;

FIG. 5 is a fragmentary perspective view of the first preferred embodiment, illustrating how a plurality of hangers are connected to the first transmission member;

FIG. 6 is a side view of the first preferred embodiment, illustrating that crops are planted in the rotary type automatic agricultural cultivating equipment;

FIG. 7 is a perspective view of the second preferred embodiment of rotary type automatic agricultural cultivating equipment according to this invention;

FIG. 8 is a perspective view of the third preferred embodiment of rotary type automatic agricultural cultivating equipment according to this invention;

FIG. 9 is a side view illustrating use of the third preferred embodiment;

FIG. 10 is a perspective view illustrating use of the third preferred embodiment;

FIG. 11 is a perspective view of the fourth preferred embodiment of rotary type automatic agricultural cultivating equipment according to this invention; and

FIG. 12 is a side view of the fourth preferred embodiment.

### DETAILED DESCRIPTION OF THE PREFERRED EMBODIMENTS

Before the present invention is described in greater detail in connection with the preferred embodiments, it should be noted that similar elements and structures are designated by like reference numerals throughout the entire disclosure.

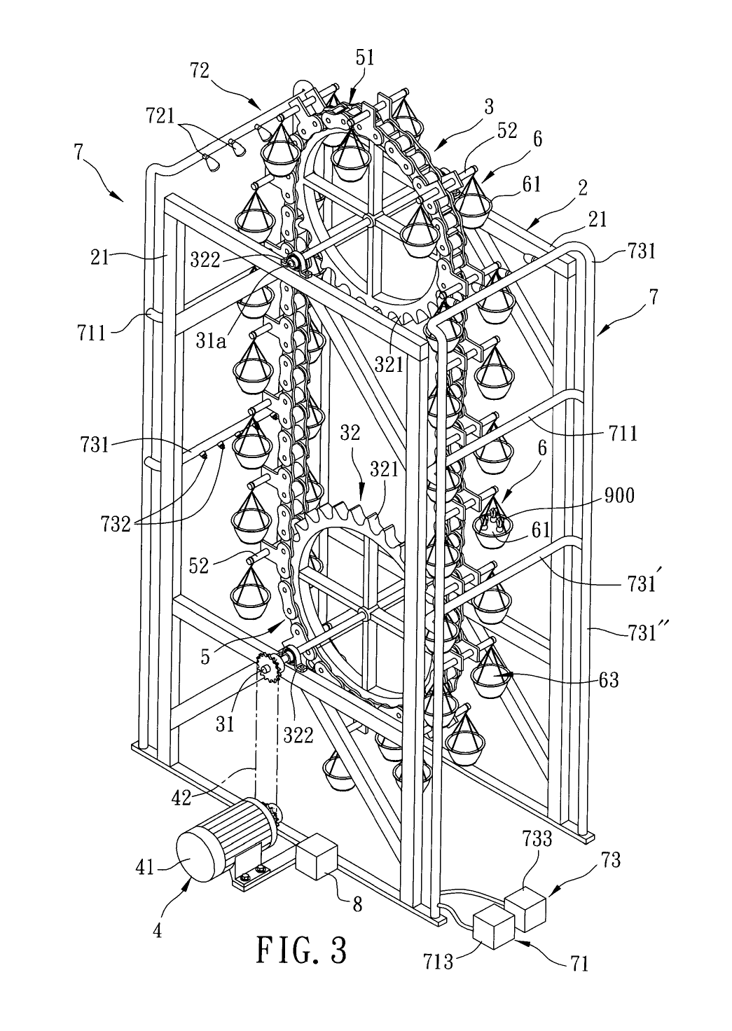

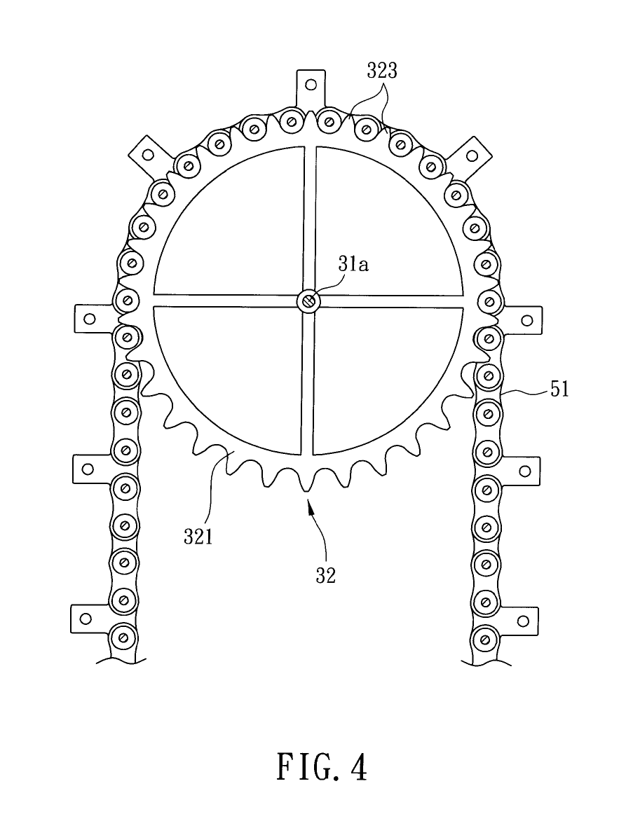

Referring to FIGS. 3, 4, and 5, the first preferred embodiment of rotary type automatic agricultural cultivating equipment according to this invention includes a support unit 2, a rotating unit 3 disposed on the support unit 2, a driving unit 4 connected to the rotating unit 3, a transmission unit 5 extending around the rotating unit 3, a plurality of loading units 6 disposed removably on the transmission unit 5, two supply units 7 adjacent to the transmission unit 5, and a control unit 8 connected to the loading units 6 and the supply units 7.

The support unit 2 includes two spaced-apart side support frames 21. The rotating unit 3 includes two axles 31, 31a disposes rotatably on the side support frames 21 and spaced vertically apart from and aligned with each other, and a first rotary wheel unit 32. The first rotary wheel unit 32 includes two first rotary wheels 321 sleeved respectively and fixedly on the axles 31, 31a. Each first rotary wheel 321 is configured as a sprocket, and has a plurality of teeth 323 along an outer periphery thereof.

The driving unit 4 includes a motor 41, and a connecting member 42 driven by the motor 41 to rotate the lower first rotary wheel 31. The transmission unit 5 includes a first transmission member 51 disposed around the first rotary wheel unit 32, and a plurality of spaced-apart hangers 52 disposed on two opposite sides of the first transmission member 51. The first transmission member 51 is configured as an endless chain, so that rotation of the lower first rotary wheel 321 results in movement of the first transmission member 51 around the first rotary wheel unit 32. Each hanger 52 has an annular groove 521.

Each loading unit 6 includes a loading body 61, and a hanging member 62 engaging the annular groove 521 in the corresponding hanger 52 for connecting the loading body 61 to the corresponding hanger 52. Each loading body 61 has a crop loading area 63. As such, each loading unit 6 can be driven by the transmission unit 5 to circulate between an upper limit position and a lower limit position.

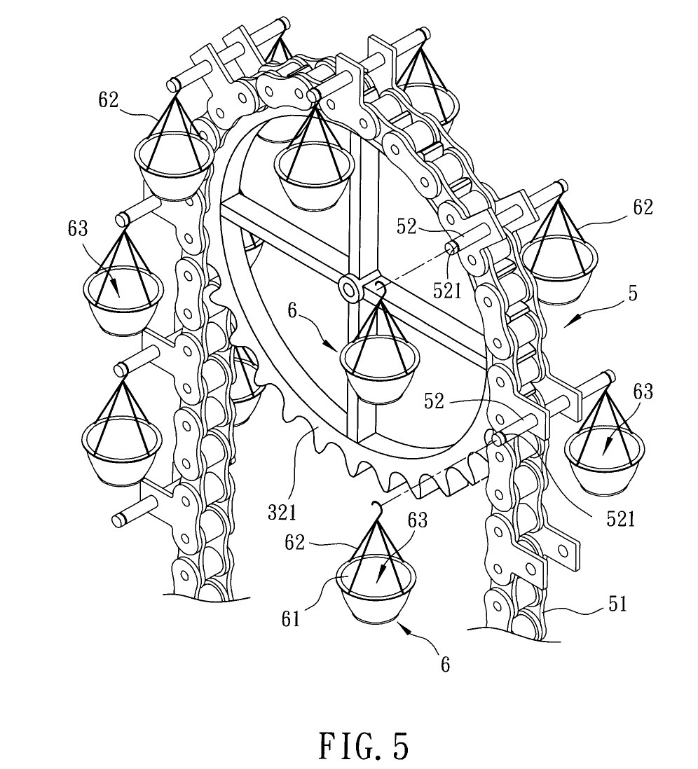

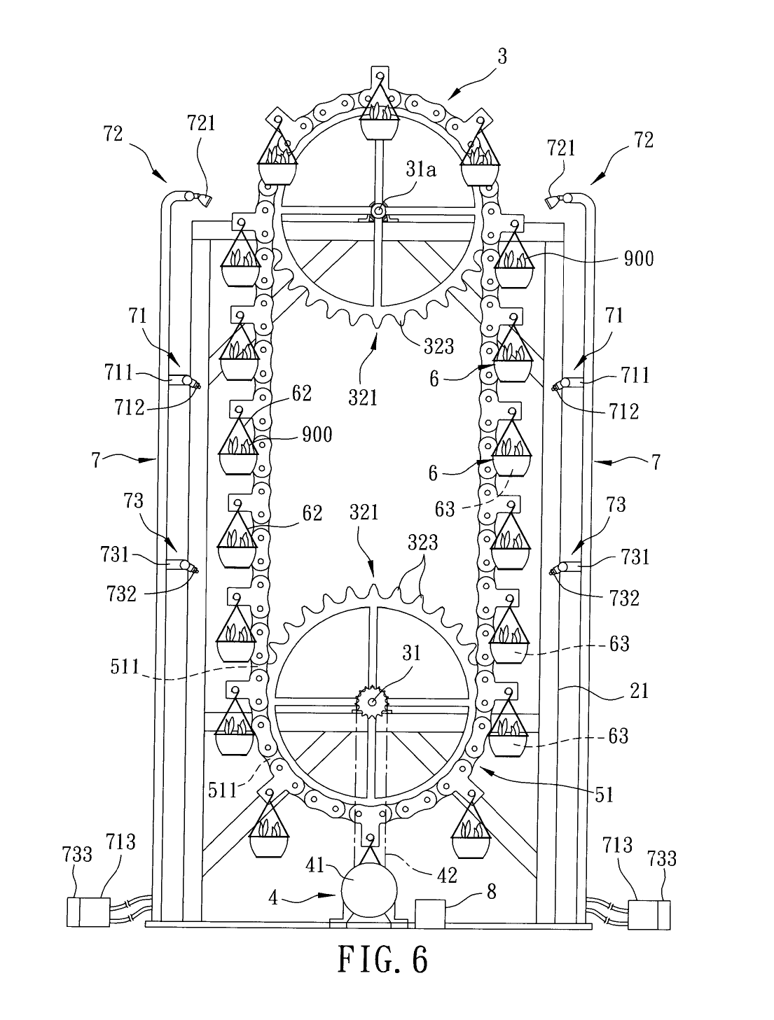

With further reference to FIGS. 5 and 6, the two supply units 7 are located respectively at two sides of the transmission unit 5. Each supply unit 7 includes a water supplying device 71 for spraying water into the crop loading areas 63 of the loading units 6, a lighting device 72 for lighting the crop loading areas 63 of the loading units 6, and a fertilizer supplying device 73 for supplying fertilizer into the crop loading areas 63 of the loading units 6. Each water supplying device 71 includes a water conduit 711 disposed adjacent to the transmission unit 5 for guiding water flow, a plurality of water spraying members 712 (only one is shown in FIG. 6) in spatial communication with the water conduit 711, and a water drawing member 713 for connecting a water source (not shown) to the water conduit 711, so as to allow for flow of water from the water source into the water conduit 711. Each lighting device 72 includes a plurality of lamps 721 disposed adjacent to the transmission unit 5. Each fertilizer supplying device 73 includes a fertilizer conduit 731 for guiding fertilizer flow, a plurality of fertilizer dispensing members 732 in spatial communication with the fertilizer conduit 731 and used for fertilizer output, and a fertilizer drawing member 733 for connecting a fertilizer source (not shown) to the fertilizer conduit 731, so as to allow for flow of fertilizer from the fertilizer source into the fertilizer conduit 731. In this embodiment, each fertilizer conduit 7 includes three horizontal sections 731′ and two vertical sections 731″ connected respectively to two opposite ends of each horizontal section 731′.

The control unit 8 is electrically connected to the driving unit 4 and the supply unit 7 for emitting a control signal to control actuation and rotational speed of the driving unit 4, the amount or time of water and fertilizer supplied from the water supplying devices 71 and the fertilizer supplying devices 73 of the supply units 7, and the lighting time, the lighting angle, or the light intensity of the lamps 721. Since operation and structure of the control unit 8 are not pertinent to the claimed invention, a detailed description thereof is omitted herein for the sake of brevity.

During use, culture liquid or soil is placed into the crop loading areas 63 of the loading units 6, and crops 900 (see FIG. 6) are planted into the culture liquid or soil. Subsequently, the hanging members 62 of the loading units 6 are hung respectively in the annular grooves 521 in the hangers 52, followed by operating the control unit 8 to activate the motor 41 of the driving unit 4. Hence, rotation is transferred from the motor 41 to the lower axle 31 and, thus, the lower first rotary wheel 321 by the corresponding connecting member 42. Due to engagement between the teeth 323 of the lower first rotary wheel 32 and the first transmission member 51 and between the upper first rotary wheel 32 and the first transmission member 51, rotation of the lower first rotary wheel 321 is transferred to the upper axle 31a and the upper first rotary wheel 321. As a consequence, each loading unit 6 circulates between the upper and lower limit positions. Such a circulation results in homogeneous growth conditions, including the amount of water, light, or fertilizer absorbed by the culture liquid or soil in the loading units 6. Furthermore, since the loading units 6 are hung respectively in the annular grooves 521 in the hangers 52, the loading bodies 61 are always open upwardly, further ensuring the homogeneous growth conditions of the crops.

It should be noted that, the connection between the rotating unit 3 and the transmission unit 5 is not limited to the engagement between the sprocket teeth 323 and the chain 51, so long as rotation can be transferred from one of the first rotary wheels 321 to the other of the first rotary wheels 321 via the first transmission member 51. In addition, the driving unit 4 may be connected directly to both of the first axles 31, 31a.

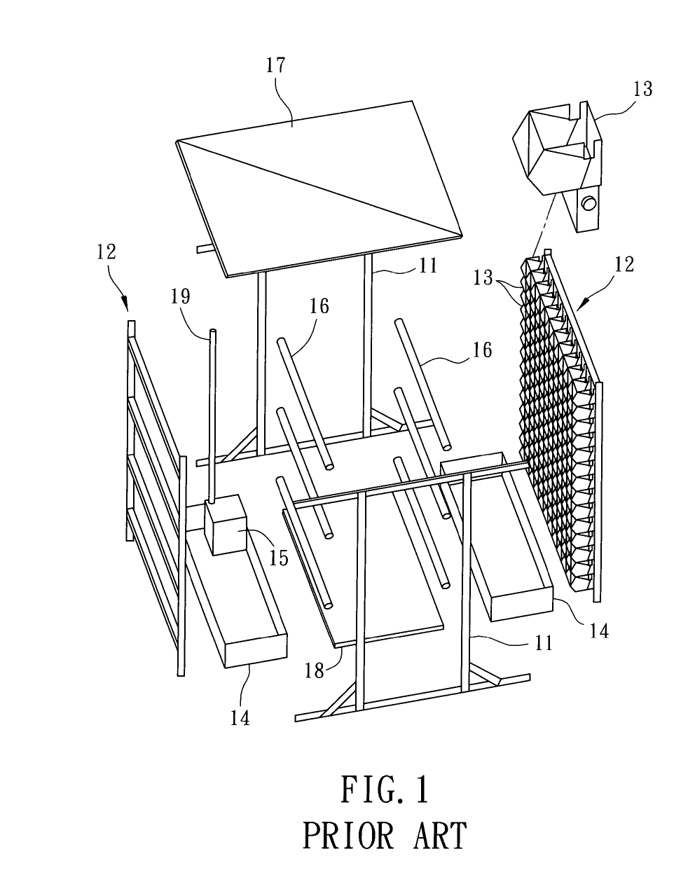

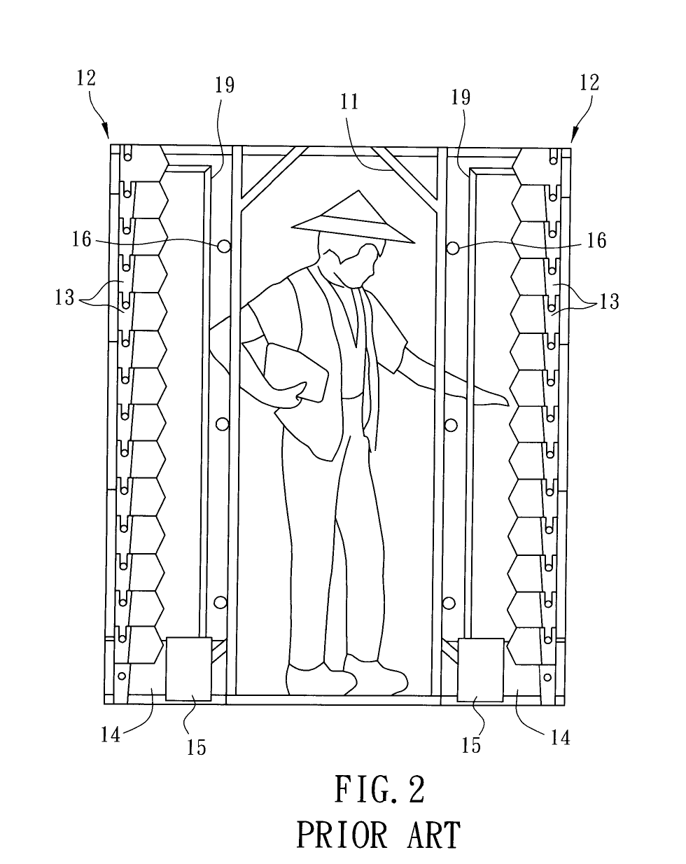

With particular reference to FIG. 6, various substances required for the growth of the crops 900 can be supplied to the crops 900 through operation of the control unit 8. Water can be supplied from the water source into the water conduit 711 by operating the water drawing member 713, and subsequently can be sprayed onto the crops 900 by forcing water from the water conduit 711 into the water spraying members 712. The control unit 8 is operable to set the amount and time of water according to the plant variety of the crops 900. When water absorbing positions of the crops 900 are different, the angle of the water spraying members 712 can be adjusted through operation of the control unit 8. With the designs of controlling the amount, time, and angle, redundant water cannot be accumulated in the loading units 6, thereby preventing difficult breathing of the crops 900 and excessive wet and messy environment. Alternatively, each loading unit 6 may be provided with a discharge hole (not shown) permitting water to be discharged therethrough, to avoid the problem of accumulation of redundant water, fertilizer, and metabolite in the lowermost flowerpots 13 (see FIGS. 1 and 2) of the above-mentioned conventional agricultural cultivating equipment.

Also through operation of the control unit 8, the angle, the lighting time, and the light intensity of the lamps 721 can be adjusted according to the growth characteristics of the crops 900, and fertilizer can be supplied from the fertilizer source into the fertilizer dispensing members 732 through the fertilizer drawing members 733 and the fertilizer conduits 731 of the fertilizer supplying devices 73 of the supply units 7.

It should be noted that, in this embodiment, the fertilizer supplied by the fertilizer supplying device 73 is liquid. In case that the fertilizer used for the crops 900 are powders or grains, the angles and the inner diameters of the fertilizer conduits 731 and the fertilizer dispensing members 732 can be adjusted to conform therewith. If necessary, the numbers or positions of the water spraying members 712, the lamps 721, or the fertilizer dispensing members 732 also can be adjusted. In addition, the lamps 721 can be replaced to emit light of a different wavelength. With these designs, the production capacity and quality of the crops 900 can be highly increased.

With particular reference to FIGS. 2 and 6, the rotary type automatic agricultural cultivating equipment of this invention has the following advantages:
(1) Uniform water absorption: Water can sprayed and distributed uniformly into the crop loading areas 63 by the water spraying members 712.
(2) Avoiding concentration of nutrient or metabolite in the culture media (i.e., culture liquid or culture soil) in specific loading units 6: In the above-mentioned conventional agricultural cultivating equipment, water flows downwardly from one of the flowerpots 13 into an adjacent one of the flowerpots 13, thereby affecting adversely the growth of the crops 900. In this embodiment, each water supplying device 71 can spray water onto the loading units 6 individually, and water cannot flow downwardly from one of the loading units 6 into an adjacent one of the loading units 6. As such, water amount in the loading units 6 is uniform. In other words, nutrient or metabolite cannot be concentrated in the culture media in specific loading units 6.
(3) Homogeneous growth conditions: In the above-mentioned conventional agricultural cultivating equipment, since the positions of the flowerpots 13 are different, the growth conditions (such as light absorbed, and temperature) of the crops 900 in the loading units 6 are also different, so that the quality of the crops 900 is non-homogeneous. In the equipment of this invention, since each loading unit 6 is circulatable between the upper and lower limit positions, the growth conditions of the crops 900 in the loading units 6 are the same. As a result, the quality of the corps 900 produced can be improved.
(4) Convenient to care by a person: since each loading unit 6 is circulatable between the upper and lower limit positions, when it is located at a height lower than that of the user, the crops 900 planted therein can be easily managed and harvested. Furthermore, when management and harvest of the crops 900 are desired, the control unit 8 can be operated to reduce the speed of the motor 41, so as to provide adequate time to facilitate easy management and harvest of the crops 900.
(5) Increasing the cultivation area: As in the above-mentioned prior art, some of the loading units 6 are spaced vertically apart from each other. The cultivation area can be increased accordingly, so that the rotary type automatic agricultural cultivating equipment is suitable for mass production.
(6) Automatic operation: Through operation of the control unit 8, the supply unit 7 can cooperate with the rotating unit 3 to supply accurate amount of water and fertilizer, so as to provide an improved culture.

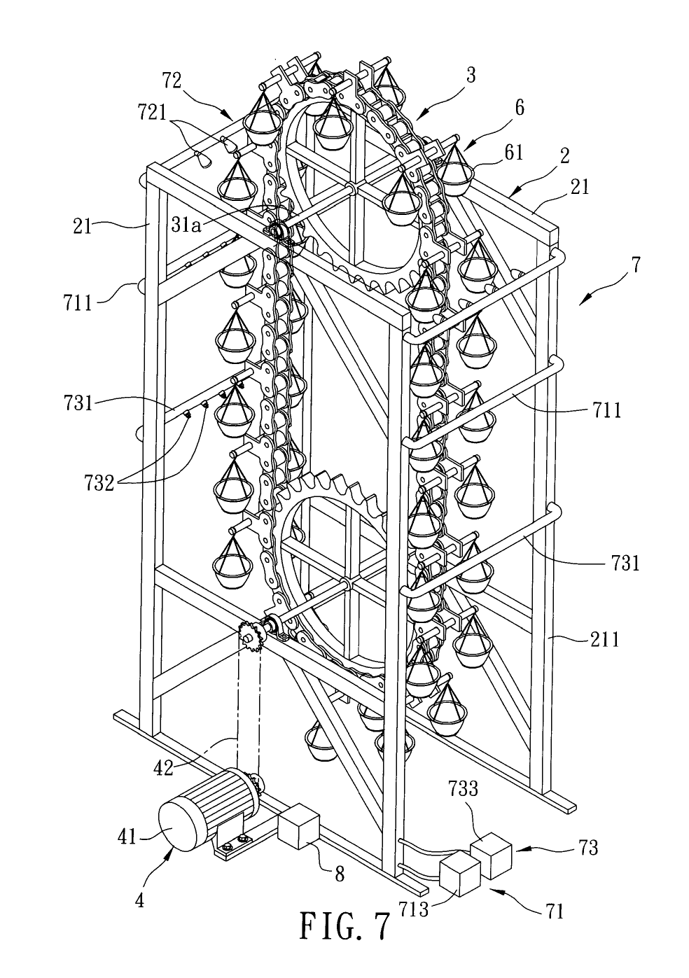

FIG. 7 shows the second preferred embodiment of rotary type automatic agricultural cultivating equipment according to this invention, which is similar to the first preferred embodiment. With additional reference to FIG. 3, the main difference resides in that, the vertical sections 731″ are omitted from the water supplying devices 73, and the horizontal sections 731′ are connected to vertical rod sections 211 of the side support frames 21. That is, in this embodiment, each vertical rod section 211 is hollow and in spatial communication with the horizontal section 731′ of the corresponding water supplying device 73.

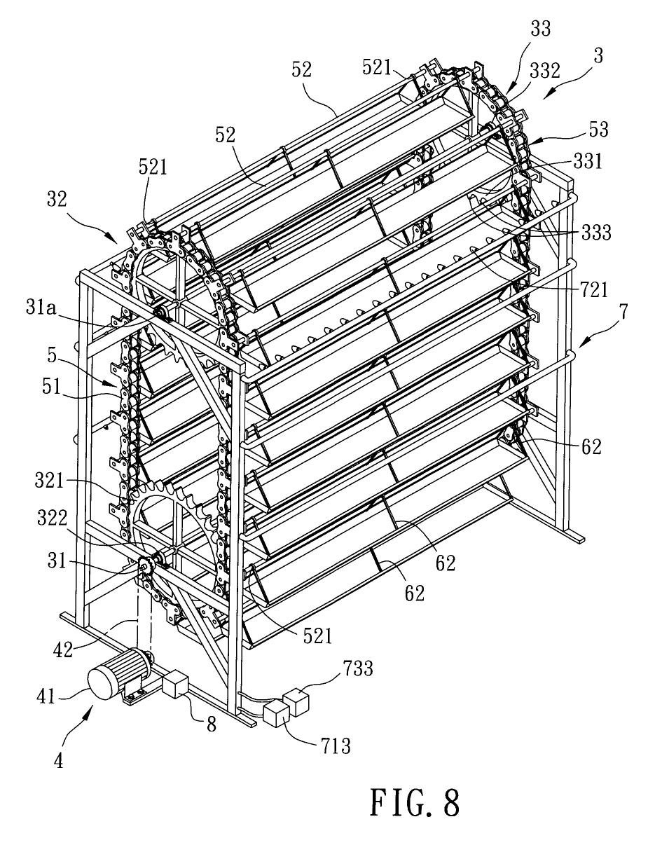

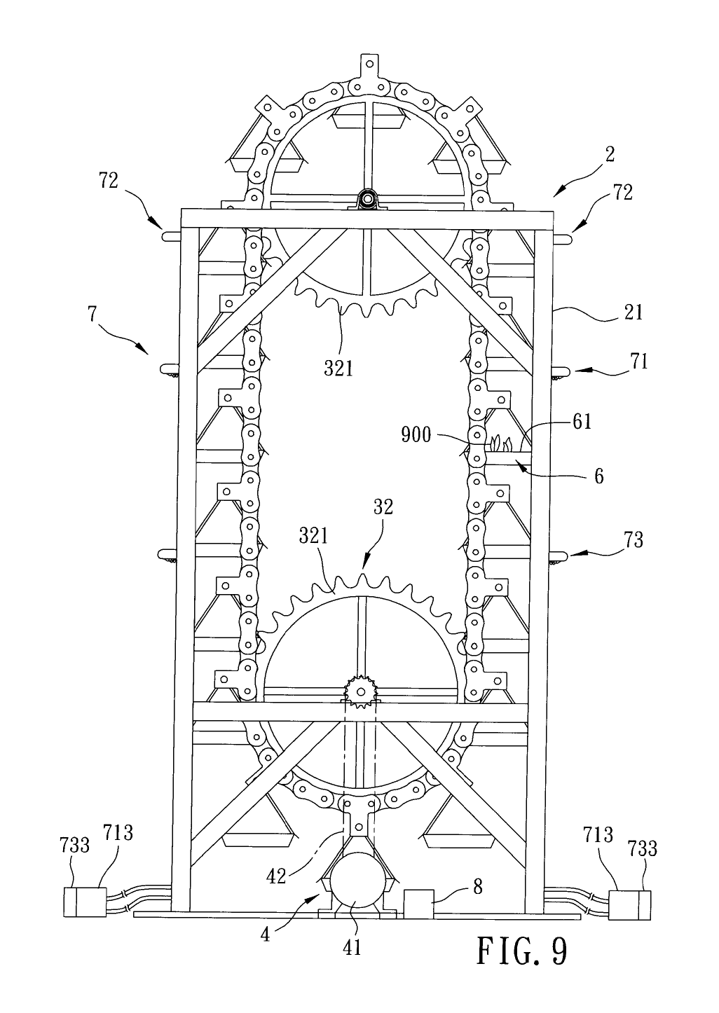

FIGS. 8 and 9 show the third preferred embodiment of rotary type automatic agricultural cultivating equipment according to this invention, which is similar to the second preferred embodiment except for the following differences. In this embodiment, the rotating unit 3 further includes a second rotary wheel unit 33, and the transmission unit 5 further includes a second transmission member 53 extending around the second rotary wheel unit 33.

The second rotary wheel unit 33 includes two vertically spaced-apart second rotary wheels 331 (only the upper one is shown) respectively and fixedly on the axles 31, 31a and aligned vertically with each other, and two vertically spaced-apart bearings 332 (only the upper one is shown in FIG. 8) each disposed between the corresponding axle 31, 31a and the corresponding second rotary wheel 331. Each second rotary wheel 331 has a plurality of teeth 333 along an outer periphery thereof. The first rotary wheel 321 and the second rotary wheel 331 that are disposed on the upper axle 31a are spaced apart from each other. Similarly, the first rotary wheel 321 and the second rotary wheel 331 that are disposed on the lower axle 31 are spaced apart from each other.

The second transmission member 53 engages the teeth 333 of the second rotary wheels 33 in a manner in which the first transmission member 51 (see FIG. 6) engages the teeth 323 (see FIG. 6) of the first rotary wheels 32. As such, rotation of the second rotary wheels 33 can be converted into movement of the second transmission member 53 around the second rotary wheels 33, and vice versa. In this embodiment, the hangers 52 are disposed between and spaced apart from the first and second transmission members 51, 53. Unlike the second preferred embodiment, each of the hangers 52 has a plurality of annular grooves 521. The hanging members 62 of the loading units 6 are hung respectively in the annular grooves 521 of the hangers 52.

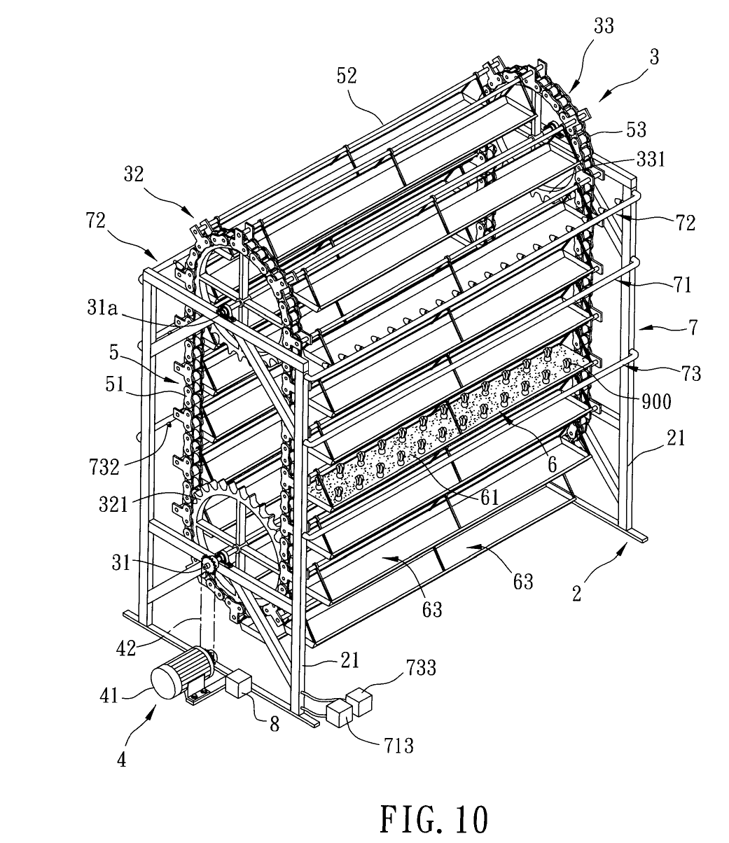

With further reference to FIG. 10, as compared to the second preferred embodiment, the crop loading area 63 of each loading unit 62 is enlarged, thereby resulting in an increase in the culture area and, thus, the production capacity of the crops 900.

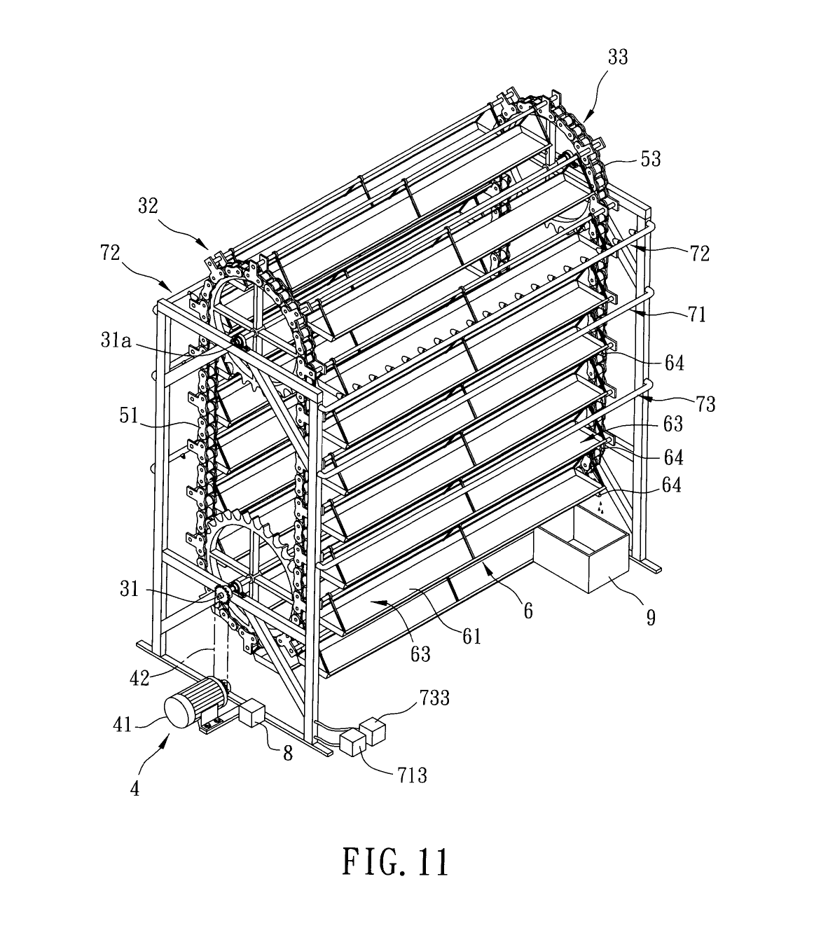

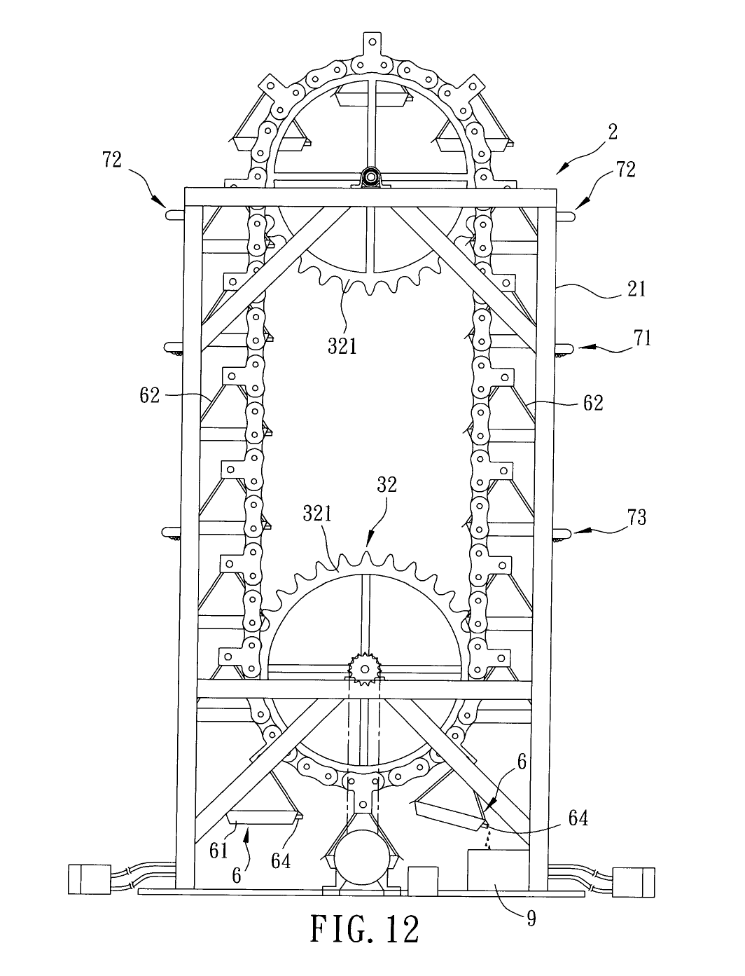

FIGS. 11 and 12 show the fourth preferred embodiment of rotary type automatic agricultural cultivating equipment according to this invention, which is similar to the third preferred embodiment. In this embodiment, each loading unit 6 further includes a water collecting tube 64 that is disposed at an upper end portion thereof, that is normally horizontal, and that is in fluid communication with the crop loading area 63, and the rotary type automatic agricultural cultivating equipment further includes a water collector 9 disposed under said loading units 6.

Since each water collecting tube 64 is disposed at the upper end portion of the corresponding loading unit 6, when it is horizontal, redundant water cannot flow out of the corresponding loading unit 6 via the water collecting tube 64. When one of the collecting tubes 64 is moved downwardly to a position disposed above and adjacent to the water collector 9, through operation of the control unit 8, the corresponding loading unit 6 can be reclined to allow redundant water to flow into the water collector 9 through the corresponding water collecting tube 64. Since nutrient, metabolite, microorganism, and bacteria may occur in the redundant water, scientific analysis can be performed on the redundant water to use as basis for improving the crops 900 planted in the corresponding loading unit 6.

Through the above designs, the fourth preferred embodiment not only can achieve the same objects as the previous embodiments, but also can collect automatically soil and water sample for composition analysis. Furthermore, the redundant water can be collect completely in the water collector 9 without dropping onto the ground, thereby facilitating maintenance of the environment.

In view of the above, some of the loading units 6 are spaced vertically apart from each other to increase the culture area and production capacity of the crops 900. Furthermore, the driving unit 4 drives the rotating unit 3 and the transmission unit 5 to allow for circulation of each loading unit 6 between the upper and lower limit positions and, thus, easy management and harvest of the crops 900. Further, the supply unit 7 can supply accurately various necessities to the crops 900. Thus, the object of this invention is achieved.

With this invention thus explained, it is apparent that numerous modifications and variations can be made without departing from the scope and spirit of this invention. It is therefore intended that this invention be limited only as indicated by the appended claims.

I claim:

1. Agricultural cultivating equipment comprising:
a support unit;
a rotating unit including two axles disposed rotatably on said support unit and vertically spaced apart from and aligned with each other, and a first rotary wheel unit including two first rotary wheels sleeved respectively and fixedly on said axles;
a driving unit connected to at least one of said axles for driving rotation of said one of said axles and, thus, a corresponding one of said first rotary wheels relative to said support unit;
a transmission unit including a first transmission member disposed around said first rotary wheel unit such that rotation of said one of said first rotary wheels results in movement of said first transmission member around said first rotary wheel unit, and a plurality of spaced-apart hangers disposed on at least one of two opposite sides of said first transmission member;
a plurality of loading units disposed respectively on said hangers, each of said loading units being circulatable between an upper limit position and a lower limit position and having a crop loading area;
a supply unit including a water supplying device for supplying water into said crop loading areas of said loading units, and a lighting device adjacent to said transmission unit for lighting said crop loading areas of said loading units; and
a control unit electrically connected to said driving unit and said supply unit for emitting a control signal to control actuation and rotational speed of said driving unit, amount and time of water supplied by said water supplying device, and at least one of lighting time, lighting angle and light intensity of said lighting device.

2. The agricultural cultivating equipment as claimed in claim 1, wherein said rotating unit further includes a second rotary wheel unit, said second rotary wheel unit including two second rotary wheels disposed respectively and fixedly on said axles and aligned vertically with each other, said first rotary wheel and said second rotary wheel disposed on either of said axles being spaced apart from each other, said transmission unit further including a second transmission member extending around said second rotary wheel unit such that rotation of said second rotary wheels results in movement of said second transmission member, said hangers being disposed between and spaced apart from said first and second transmission members.

3. The agricultural cultivating equipment as claimed in claim 2, further comprising a water collector disposed under said loading units, each of said loading units further including a water collecting tube in fluid communication with said crop loading area so as to allow redundant water in said crop loading area to flow into said water collector through said water collecting tube.

4. The agricultural cultivating equipment as claimed in claim 3, wherein said control unit is further electrically connected to said loading units, and is operable to recline a selected one of said loading units so as to allow the redundant water to flow into said water collecting tube of the selected one of said loading units.

5. The agricultural cultivating equipment as claimed in claim 1, wherein said water supplying device includes a water conduit disposed adjacent to said transmission unit for guiding water flow, a plurality of water spraying members in spatial communication with said water conduit, and a water drawing member adapted for connecting a water source to said water conduit so as to draw water from the water source into said water conduit, said lighting device including a plurality of lighting members adjacent to said transmission unit.

6. The agricultural cultivating equipment as claimed in claim 1, wherein said supply unit further includes a fertilizer supplying device adjacent to said transmission unit for supplying fertilizer into said crop loading areas of said loading units.

7. The agricultural cultivating equipment as claimed in claim 6, wherein said Fertilizer supplying device includes a fertilizer conduit for guiding fertilizer flow, a plurality of fertilizer dispensing members in spatial communication with said fertilizer conduit and used for fertilizer output, and a fertilizer drawing member adapted for connecting a fertilizer source to said fertilizer conduit so as to draw fertilizer from the fertilizer source into said fertilizer conduit.

8. The agricultural cultivating equipment as claimed in claim 1, wherein said first rotary wheels are configured as sprockets, and said first transmission member is configured as a chain.

9. The agricultural cultivating equipment as claimed in claim 2, wherein each of said first and second rotary wheels is configured as a sprocket, and each of said first and second transmission members is configured as a chain.
